(19) United States
(12) Patent Application Publication
(10) Pub. No.: US 2015/0028667 A1
(43) Pub. Date: Jan. 29, 2015

(54) ELECTRONICALLY CONTROLLABLE BRAKE ACTIVATION SYSTEM

(71) Applicant: IPGATE AG, Pfäffikon Sz (CH)

(72) Inventors: Heinz Leiber, Oberriexingen (DE); Valentin Unterfrauner, Munchen (DE); Christian Koeglsperger, Geretsried (DE)

(73) Assignee: IPGATE AG, Pfäffikon Sz (CH)

(21) Appl. No.: 14/358,118

(22) PCT Filed: Oct. 31, 2012
(86) PCT No.: PCT/EP2012/071593

§ 371 Date: Sep. 16, 2014

(30) Foreign Application Priority Data
Nov. 14, 2011 (DE) 102011118365.9

(51) Int. Cl. B60T 11/10; B60T 15/02; B60T 11/28; B60T 11/20; B60T 7/04

(52) U.S. Cl. CPC B60T 11/103; B60T 11/203; B60T 7/042; B60T 11/28; B60T 15/028
USPC 303/15

(57) ABSTRACT

The invention relates to an electronically regulable brake system, with an actuating device, in particular a brake pedal, a main brake cylinder arrangement with at least two parallel arranged piston cylinder units and a reservoir, which are connected via hydraulic lines and valves to wheel brakes, and with a servo mechanism. According to the invention an electrically drivable valve device (BV1, BV2, EA) is provided between the brake circuits allocated to the piston cylinder units (16, 17), in order to allow the regulated transfer of hydraulic fluid between the brake circuits (bypass) and the reservoir (24).

### PRIOR ART

The trend of future braking force and brake regulating systems aims to integrate all functions in one structural unit. In this connection the following factors are in the foreground:
Structural size and weight, structural length and cost
Fail-safe operation
Functionality of ABS/ESP and for all support functions
Diagnosis

Important components that determine the structural size, weight and cost are the number of pistons (K), magnetic valves (M) and sensors (S), electric motor (E) and arrangement of all the components. The fail-safe operation is determined by the number of functionally relevant components, their switching and selection of construction principles that have hitherto proved effective in this field. Also diagnosis is an essential element of early failure recognition of individual failures so that critical double failures do not occur. Functionality includes high dynamics for the ABS, ESP systems and all known support functions.

From DE 195 38 794 a system is known that is constructed in a similar way to the electrohydraulic brake (EHB) (see Brake Manual, Vieweg-Verlag) with a tandem main cylinder (TMC), an electromotive pump unit, a plurality of magnet valves, sensors and pistons. With an intact pump unit this acts as brake servo and pressure means feed to the brake circuit. In the illustrated system the pressure reduction takes place in a storage chamber, in a known (but not illustrated) system via a return line to the reservoir. This system is, with its many pistons, magnet valves and sensors, extremely complicated, but has a short structural length since the TMC and motor are not coaxially arranged. In the aforementioned more recent version the path simulator is no longer integrated in the TMC, but is mounted externally over a magnet valve.

In DE 10 2011 017436 a concept is illustrated having a coaxial arrangement of motor and TMC and axially parallel auxiliary pistons for the path simulator (PS) actuation. A further feature is the assembly of all sensors in one module.

An important component in this connection is the TMC, which is used for the brake servo (BS) and pressure modulation. The latter is advantageously used with the multiplex (MUX) principle, as is described for example in DE 2020 05018018, which reduces the spacing between DK and SK pistons. Also, with a larger volume requirement this is further delivered via the main cylinder piston valves to the reservoir.

A major advantage of the coaxial construction is, as for example also illustrated in DE 10 2011 009 059, the possibility, in the event of failure of various components, for example WS, to switch to so-called follower servos, in which the foot force co-operates with the brake servo, but with longer pedal paths.

The tandem main cylinder determines with the structural length and the oppositely working piston springs, the MUX function and the further delivery at low μ. A known possibility of economising in structural length is the twin arrangement of the main cylinder piston, as is illustrated for example in DE 392 88 73, DE 37 23 916 or DE 27 53 585.

A problem of the twin arrangement is pressure compensation with asymmetric volume uptake of both brake circuits. For this, a rocker is used as compensation at the inlet of the main cylinder piston or at the outlet through a compensation piston. Both have the same problem in the event of a failure of a brake circuit, in that they restrict the compensation volume, which involves the intact brake circuit in additional volume and reduces the maximum possible pressure and braking action.

### OBJECT OF THE INVENTION

The object of the invention is to improve a brake actuating system of the generic type mentioned in the introduction, so that the available compensation volume is sufficiently large and pressure and braking action are not adversely affected.

### Solution of the Object

The object of the invention is achieved by the features of claim 1.

In order to reduce the structural length a twin arrangement with fail-safe parallel switching of the two brake circuits via suitable magnet valves and dimensioning is used. In addition a high fail-safe operation is achieved, assisted by an effective failure diagnosis. The piston actuation can take place in various ways, either hydraulically, piezomotively or preferably electromotively. The bypass switching must function reliably, which is checked either before starting the vehicle or during braking. Here it is advantageous to carry out the bypass switching in the low pressure range for the volume compensation. As is known, the air play of the brake shoes on the individual wheel brakes is very different. If this range, for example greater than 10 bar, is exceeded, then the bypass switching may be cancelled. For reasons of fail-safe operation the closing spring forces of the bypass valves are designed large, in order to allow still sufficient residual pressure in the event of double failure brake circuit breakdown and bypass magnet valves not closing for example due to dirt. For this purpose it is necessary at pressures for example greater than 50 bar to reactivate the bypass switching.

With ABS/ESP the bypass switching must be present, since in the braking circuits different pressure levels exist, which constantly vary especially in MUX operation. In the limiting case, with non-bypass switching even underpressure could occur at P_{ab}. Furthermore bypass switching is advantageous in the empty path release, since in contrast to the tandem arrangement the distances between the pistons are not altered. Also, bypass switching is advantageous when aspirating fluid from the reservoir via an inlet and outlet valve (EA valve) for the further delivery, including inter alia a further pressure rise. The collar seal can thus be designed for underpressure, so that the brake lining play can be used without extra effort with reduced pressure according to DE 10 2008 051 316. The pistons are actuated via a pressure plate by the spindle of the electric motor or, if this fails by the pedal push rod.

Here too a coupling is necessary, preferably with a permanent magnet, as described in DE 10 2010 044 754 of the applicant, to which reference is made here, in order at low pressure at P_{ab} to retract the piston quickly to low μ. Compared to the TMC application, in the aforementioned case the magnet diameter is no longer determined by the piston diameter but can be chosen freely, which can be employed for higher restoring forces or when using a cost-efficient, e.g. plastic-bonded, magnet.

In the twin arrangement of the pistons asymmetric forces are produced, which can be trapped by the pressure plate with guide bolts mounted in the main cylinder housing. Also these undertake the necessary torque support of the spindle, whose flange is connected by positive engagement to the pressure plate. Each system requires a spindle resetting in the event that the motor fails, which as a rule is performed by springs, whose displacement and installation are complicated. Here this spring in the bore of the guide bolt can act with little effort directly on the spindle flange.

Also the resetting of the pistons can be displaced outwardly from the piston cylinder, which reduces the cost of the pistons and improves the ventilation possibility. Instead of the bypass magnet valves a compensation element between the brake circuits with two pistons can also be used, which in the aforementioned prior art is controlled via magnet valves. This compensation element is switched off in the event of a brake circuit failure. If the brake servo fails additional volume can be supplied via a feed valve to the two pistons, which supply the additional volume to both brake circuits, DE 10 2010 045 6217. Without a compensation element this valve acts directly on both brake circuits via the bypass magnet valves.

The bypass valve switching consists of one bypass magnet valve per brake circuit with a central EA magnet valve for the reservoir. This is used for the free path switching, in which the corresponding volume is vented into the reservoir and also for aspiration for the further delivery. This inlet-outlet magnet valve can also be dimensioned large in cross-section, which is necessary for rapid aspiration. This valve is open for the aforementioned functions or for diagnostic purposes. As already mentioned, the bypass magnet valves are temporary open. A possible leakiness is detected in this case via the known assignment of pressure or motor current to the piston travel. As is known the MUX systems have the pressure-volume characteristic in the memory.

The system is designed for diagnosis so that a reliable failure detection takes place during braking. A diagnosis before starting the vehicle should take place without pressure loading of the wheel cylinders. Also, a separate pedal movement should not be necessary for the diagnosis.

For the diagnosis of the bypass magnet valves no bypass switching of the circuits takes place, and the inlet-outlet valve is opened. Here too failures, for example in the valve switching, and a leakiness are detected by the diagnosis. If now a double failure occurs due to circuit malfunction and leaky bypass magnet valve, the powerful closing springs thus prevent up to 80 bar pressure an overflow into the intact brake circuit. Relevant legislation does not require safety against double failures, since the probability of occurrence of individual failures is very low.

Instead of a plurality of bypass magnet valves one magnet valve can also be used, in addition preferably in each case with an inlet-outlet valve for intake from the reservoir.

The twin arrangement can also be used for conventional valve switching with an inlet and outlet valve, as described in the aforementioned prior art. In this connection no additional plunger pump with isolating and safety valves is necessary. The further supply is provided by the twin pistons with rapid intake via the inlet-outlet valve. Here the advantageous coaxial arrangement can additionally be used. For this purpose it is necessary however for the inlet-outlet valve to be specially dimensioned, in order still to be able to switch at large pressure differences.

The complexity of the valve set-up can be reduced if only the front wheels are regulated with inlet and outlet valves and the rear wheels via MUX. It is also conceivable in the case of small front-wheel drive cars or electric vehicles to regulate the rear wheels jointly, as was the case with the introduction of ABS.

A further simplification is in the design and construction of the path simulator. This has in principle three zones, namely a weak zone 1, middle zone 2 and strong pressure rise in zone 3 via the pedal path. Zone 1 can be configured via the pedal restoring spring. After reaching a certain pedal stroke the zones 2 and 3 are then activated via the path simulator switch-on magnet valve. For this purpose the path simulator must be correspondingly configured with a transition region from 1 to 2 or the aforementioned must be triggered via pulse-width modulation (PWM) in order to form the transition function.

The path simulator characteristic can in addition be disconnected adaptively, if for example the switch-on point is advanced to low μ when the ABS function is used. Also, with high pedal speed the switching point can be displaced and then set to a longer pedal path.

The illustrated valve switchings have no advantage as regards cost compared to the fourth channel MUX, although the proved and tested regulating algorithms can be used.

As is known the piston dimensioning with the pedal conversion is decisive in order to achieve high pressures in the fallback position. Since on the other hand however the volume is restricted with possibly the pedal/main cylinder stroke, a larger volume must be achieved via further delivery.

As an alternative an additional piston is provided, as is illustrated and described in an earlier application DE 102011112515 (E130) of the applicant, to which reference is specifically made in this connection. Such additional pistons can also be used in the twin arrangement. Since the force transmission to the spindle is designed in any case for asymmetric forces, a piston with corresponding bypass switching can also be used.

With the solution according to the invention and its embodiments an optimum effect is achieved in the aforementioned points (1 to 4) and the disadvantages of the mentioned prior art are obviated.

### DESCRIPTION OF THE FIGURES

The invention and its embodiments and modifications are described in more detail hereinafter.

In the figures:

FIG. 1: shows an actuator with sensors, path simulator and valves;

FIGS. 2, 2a: show a section with pressure plate and guide bolts;

FIG. 3: shows a circuit diagram of the bypass valves;

FIGS. 4a and 4b: show various valve switchings;

FIG. 5: shows the operation of the adaptive path simulator, and

FIG. 6: shows a further embodiment of the actuating system.

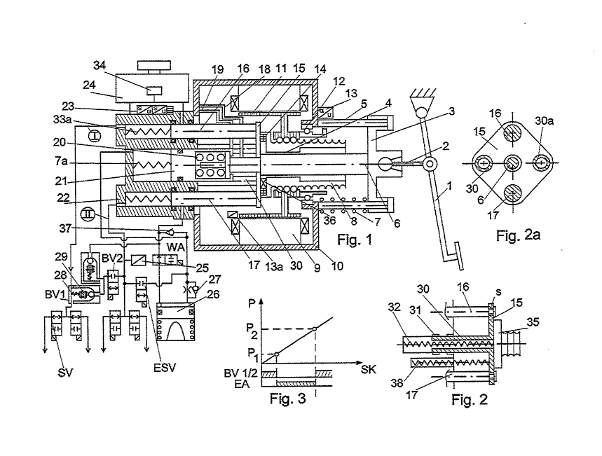

FIG. 1 shows the structure of a brake actuating system with a twin actuator. An EC motor with stator 9, rotor 11 with bearing 12 and spindle 8 is installed in the housing 10. The rotor 11 acts in a known manner on the spindle 8. For the motor control, not illustrated, a motor rotational angle sensor 13 is necessary, from which also the piston stroke is calculated. The motor is controlled via the pedal movement and the corresponding sensors 23. The pedal 1 acts in this connection via the pedal plunger 2 on the pedal plate 3 with rod 6. The pedal plate is mounted on guide bolts 5 in order to absorb the relatively small transverse forces in the pedal movement. The rod acts on the one hand via the pressure plate 15 on the main cylinder pistons 16 and 17 and in parallel via the pre-tensioned spring 20 on the auxiliary piston 21. The rod movement is guided via the sensor actuation 18 to the master and the movement of the auxiliary piston via 19 to the slave sensor. The pedal force can thus additionally be evaluated via the spring and the differential path, as illustrated in detail in DE 1020 10050132, to which specific reference is made here.

The two sensors can together with the motor encoder 13 or alternative 13a be combined in a sensor module on the main cylinder housing 22 with a plug for the adjacent ECU. In the normal case the spindle flange 35 acts with a suitable coupling device, here in particular a permanent magnet 14, on the pressure plate 15 and pistons 16 and 17 and thereby generates the desired pressure. The coupling device or permanent magnet is, as already previously described, necessary in order at low μ to generate a rapid return movement with low compressive force on the piston including piston restoring spring, so as quickly to relieve the pressure.

The torque of the spindle is also supported in the pressure plate via a corresponding positive engagement connection 36 in the spindle flange 35. The pressure plate is mounted on two guide bolts 30 and is described in detail in FIGS. 2 and 2a. The movement of the pedal and rod acts on the auxiliary piston, whose volume reaches WS 26 via a conventional throttle non-return element 27. In this connection the WS switch-on valve WA is closed. A further movement of the auxiliary piston acts on the WS springs, which produce the desired pedal force-path function. The auxiliary piston is connected to a non-return valve 37, which prevents air being aspirated in the event of a rapid backward movement.

As regards the path simulator, an alternative set-up with adaptive WS characteristic is also illustrated in FIG. 5. The two pistons 16, 17 supply volume and thus braking pressure in circuits I and II. A pressure transducer is used in circuit II. This is basically used for recording the (p) pressure=(V) volume (piston path/characteristic). This is used for the ABS regulation and monitoring of the brake circuit.

The two pistons generate corresponding to the p-V characteristic a pressure in the brake circuit that can be different in both brake circuits. A bypass switching is therefore provided. For this purpose it is necessary to reactivate the bypass switching at pressures greater than 50 bar for example.

The bypass switching must be present with ABS/ESP, in which the valves BV1 and BV2 are open, since different pressure levels exist in the brake circuits, which vary constantly especially in MUX operation. In the limiting case, with non-bypass switching as is illustrated in FIG. 1 even reduced pressure could occur at P_{ab}. Furthermore, parallel switching is advantageous in the empty path release, since in contrast to the tandem arrangement the distances between the pistons are not changed. Also, bypass switching is advantageous when aspirating fluid from the reservoir via an inlet and outlet valve for further delivery, inter alia for the further pressure increase. The collar sleeve is therefore resistant to reduced pressure, so that the brake lining play can be used without extra effort with reduced pressure according to DE 10 2008051316.

This bypass set-up must operate reliably, which is checked either before starting the vehicle or during braking. Here it is advantageous to perform the bypass switching in the low pressure range for volume compensation. As is known, the play of the brake-shoes is very different for the individual wheel brakes. If this range, for example greater than 10 bar, is exceeded, then the parallel or bypass switching may be cancelled. For reasons of fail-safe operation the closing spring forces 28 of the bypass valves with anchor and coil 29 are designed large, in order to allow still sufficient residual pressure in the event of double failure brake circuit breakdown and bypass magnet valves not closing for example due to dirt.

The bypass valve switching consists of a bypass magnet valve BV1 and BV2 with a central inlet-outlet magnet valve for the reservoir. This is used for the empty path release, in which the corresponding volume is vented into the reservoir, and for aspiration for the further delivery from the reservoir. This EA magnet valve can be dimensioned large in cross-section (in particular >5 mm²), which is necessary for rapid aspiration. This valve is open for the aforementioned functions or for diagnostic purposes. As already mentioned, the bypass magnet valves are temporary open. A possible leakiness is recognised in this case via the known allocation of pressure or motor current to the piston stroke. As is known, the MUX systems have the pressure volume characteristic in the memory.

The bypass switching follows the four switching valves SV, which are known for the individual wheel regulation by MUX.

Due to the small described piston dimensions on account of the fallback situation, this results in long pedal paths. This can be considerably reduced by feeding volume from the auxiliary circuit by means of the auxiliary piston into the brake circuit II and via the bypass magnet valves also in brake circuit I.

The brake system also includes an electronic control and regulating unit (ECU), which is not shown here and to which all electrical and electronic components are connected.

For safety-relevant systems the early failure diagnosis is of great importance. These include in particular component failures, faults in the brake circuit and in particular brake circuit breakdown, which is particularly important in a twin arrangement with parallel switching of the brake circuits. The storage of the pressure-volume characteristic in the memory of the ECU for the accurate pressure regulation of ABS has already been mentioned. This takes place during start-up of the vehicle, whereby the motor drives the pistons 16, 17. A piston path (=volume)-dependent pressure is thereby produced in the brake system as a basis for the brake circuit diagnosis for tightness.

Test 1: Measurement of pressure (motor phase current) and piston path up to 100 bar with bypass switching.

Test 2: Measurement of the individual wheel pressure-volume characteristic, in which a valve SV is open in the corresponding brake circuit (for example I) and all other valves V are closed. The valves EA and BV2 are open. Pressure is thus generated only in circuit I. This continues for all other wheel circuits.

Test 3: Brakes circuits I and II. This test is carried out at all service intervals. During the operating time of the vehicle the tests 1 and 3 are carried out before starting the vehicle, if for example the piston path (=volume) has changed when braking at a certain pressure. A complete BKA recognition is thus provided also during the ABS regulation, which takes place advantageously in closed brake circuits. An exception is the short-term empty path switching at low μ. The volume withdrawal is however known via the piston setting, so that this value is involved in the changed pressure-volume characteristic and can thus be used subsequently for the BKA recognition. If a leak or a BKA occurs, then the bypass switching is cancelled. In the case of a small leak this can be compensated by further delivery with triggering and warning notification so long as there is still sufficient fluid in the reservoir. If the leak is outside the HCU, this circuit can be separated by closing the corresponding wheel valve SV, so that then an effective three-circuit brake system is possible, even with ABS function. This can be decisive for avoiding accidents at low μ. The description of the switching of the recognition of this leak is omitted here, since the principle of BKA recognition has been described. As an alternative to the pressure the motor current can also be used in general or in parallel to the pressure transducer.

Test 4: Tightness of the bypass switching. Bypass valve BV1 and BV2: corresponding braking pressure >10 bar. The valve EA is open and the bypass valves BV1 and BV2 are closed, as illustrated in FIG. 3. Comparison of pressure, motor current with piston path. This test conveniently takes place automatically with each braking action.

Test 5: Tightness of the EA valve. The valves BV1 and BV2 are open, the valve EA is closed. The further course is as in test 4. No additional tests are necessary.

Should a small leakiness be detected in test 3 and 4, then this test can be repeated and quantified when the vehicle is stationary.

With larger degrees of leakiness a corresponding warning notification is given. For the described further delivery the importance of the liquid level transducer, which should advantageously be fail-safe, applies to all systems or cases with this feature. In DE 10 2011 174 36 of the applicant a sensor module inter alia was described, which allows this feature.

Test 6: In the description of FIG. 1 it was mentioned that the spring 28 of the bypass valve BV has a powerful closing force for the case of a double failure brake circuit breakdown and leakiness of the BV valve. For this test of for example valve BV1, first of all a pressure release takes place at ca. 50 bar in the circuit I via BV 1 and EA valve open. Then a pressure rise to >80 bar occurs in the circuit I at a corresponding closing force of BV1. The opening pressure of BV1 is recognised via the pressure (current) piston path relationship. The same applies to BV2. On account of the low failure probability this test is necessary only during the service interval. If the spring breaks the spring force drops only slightly with appropriate winding spacing and spring constant, which are correspondingly optimised in the construction of the magnet valves.

The switching function is automatically covered by the aforementioned tests. The electrical connection of the magnet valves is included as standard with all ESP by current measurements. The remaining valves ESV, WA and WS are also possible in the diagnosis and are described in earlier applications of the applicant.

With the described tests it was shown that the bypass switching of the twins is fail-safe through corresponding diagnosis. After failure recognition the bypass switching and ABS function are no longer active, so that two closed brake circuits are available with possibly a slight asymmetry in the pressures, which is acceptable bearing in mind the warning notification and low failure probability.

FIG. 2 shows the pressure plate 15 with guide bolts 30, which preferably moves in sliding bearings 31 in the main cylinder housing. The pistons 16 and 17 are mounted floating with a play s in the pressure plate, and thus a transverse movement of the pressure plate does not act on the pistons. The spindle restoring spring 32 acts through the bore on the spindle flange 35. As an alternative to the conventional piston restoring springs 33a in the cylinder, these can also be replaced by a restoring spring 33 on the pressure plate 15 with the described advantages.

FIG. 2a is a plan view 19 of the pressure plate in a section through the pistons 16, 17, with two guide bolts 30 and 30a arranged displaced by 90° thereto. The centrally arranged rod 6 acts via the pressure plate. In this connection it is also clear that if the pressure force of a piston fails the asymmetric force is absorbed by the guide bolts.

FIG. 3 shows the already described switching of the bypass and EA magnet valves via pressure and piston path S_{K}.

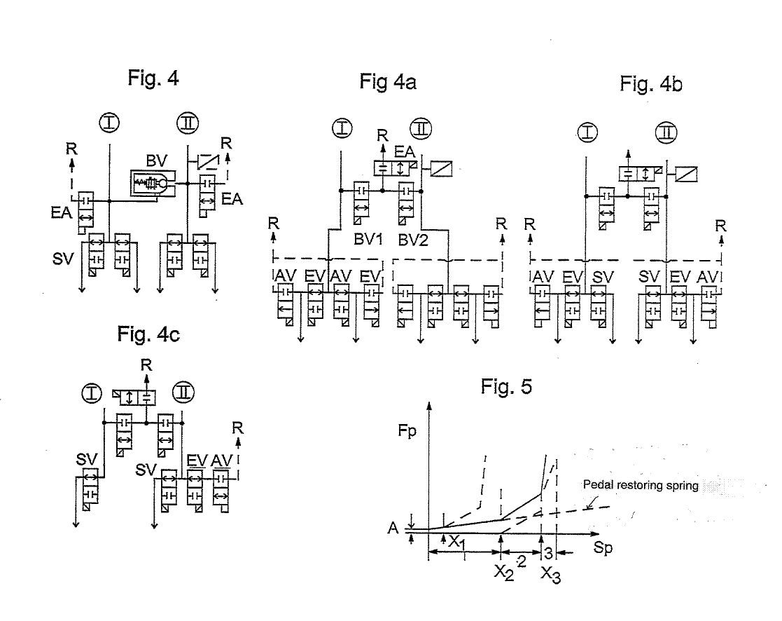

In the embodiment according to FIG. 4, instead of a plurality of bypass magnet valves one magnet valve is used together with preferably one EA valve for each circuit for intake from the reservoir. In this connection a leak test by generating different pressures in the brake circuits is necessary before each start of the vehicle.

According to FIG. 4a the twin arrangement can also be used for the conventional valve switching with one inlet valve (EV) and one outlet valve (AV) per wheel brake, as described in the aforementioned prior art. In this connection no additional plunger pump with isolating and safety valves is necessary. The further delivery is performed by the twin pistons with rapid aspiration via the EA valve. Here the advantageous coaxial arrangement can additionally be used. For this purpose it is however necessary that the EV is specially dimensioned so that it is still able to switch at large pressure differences.

The valve switching can, as illustrated in FIG. 4b, be reduced in complexity compared to the variant according to FIG. 4a if only the front wheels are regulated with EA and AV and the rear wheels via MUX. It is also conceivable to regulate the rear wheels jointly in small front-wheel drive cars or electric vehicles, as was the case in the introduction of ABS, as illustrated in FIG. 4c.

A further simplification is in the design and construction of the path simulator. As illustrated in FIG. 5, this in principle has three zones, with a weak zone 1, middle zone 2 and strong pressure rise in zone 3 via the pedal path. Zone 1 can now be configured via the pedal restoring springs 7, 7a. After reaching a certain pedal stroke the zones 2 and 3 are then activated via the path simulator switch-on magnet valve. For this, the path simulator WA must be configured with a transition region from 1 to 2 or the aforementioned must be triggered via pulse width modulation (PWM).

The path simulator characteristic can in addition be adaptively separated, in which for example the switch-on point is advanced to low μ if the ABS function is used. Also, at high pedal speed the switching point can be shifted and then to a longer pedal path.

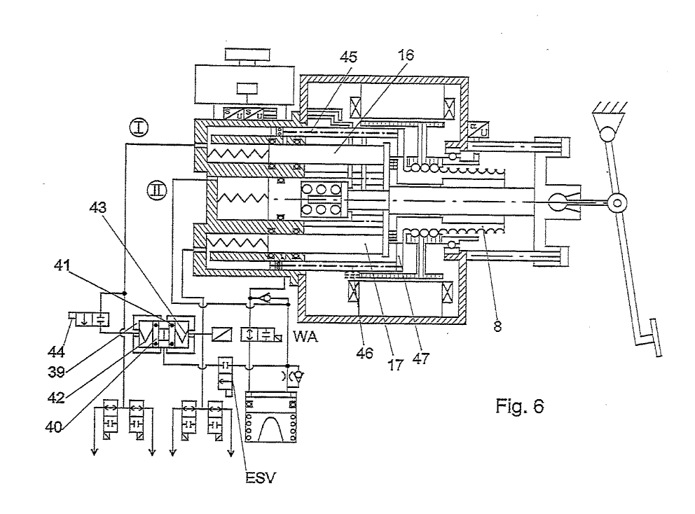

FIG. 6 shows an expansion of the system with additional pistons 45 and 46, which are actuated by an actuating arm 47 of the spindle 8. In the event of a failure of the BKV (brake servo) only the primary pistons 16 and 17 are actuated by the pedal. The valves BV1 and BV2 are here replaced by a compensation piston 40, 41. The compensation piston can be made in one part or, as illustrated, in two parts.

The compensation piston is held by corresponding springs 42 and 43 in a floating mid position. It can be actuated hydraulically from both sides and can therefore provide a certain compensation volume to each brake circuit. As mentioned in the introduction, this is necessary in order to compensate different volume intakes of the wheel brakes but also to compensate different pressure and volume levels in ABS braking. For example, with p-jump manoeuvres the necessary differential volume in the case of conventional vehicles with axle-type brake circuit distribution (s/w) may for example be 4 cm³.

Such compensation pistons in conjunction with twin main brake cylinders are known and suffer from the problem that if there is a brake circuit failure the compensation volume (e.g. 4 cm³) is taken from the intact brake circuit. Therefore the effective residual volume in the intact circuit is, depending on the circumstances, no longer sufficient for the legally required minimal residual braking action. The difference compared to the prior art can eliminate this problem due to the use of the components E/A valve (add number), shut-off valve 44 and two-part compensation pistons 40 and 41 with feed from the auxiliary piston 21, described hereinafter.

As a first measure, in the proposed system volume from the reservoir can be supplied to the intact brake circuit via the E/A valve, so that the full braking action can be achieved in the brake circuit.

In the event of a double failure “breakdown of brake servo and brake circuit” this is however no longer possible, so that in this case the residual braking action can fail completely. For this, a current-free closed valve 44 can be used as remedial measure. In the event of a brake failure this prevents the compensation movement of the compensation piston 40, 41 and thus the volume loss in the intact brake circuit.

This valve can be used with functional BKV and in “brake circuit failure” recognition in order to suppress here too the compensation movement. The recognition is unambiguous due to a marked deviation of the pressure-motor current assignment, since in the case of a brake circuit failure and open valve 44 no pressure can build up also in the intact brake circuit and the motor current is therefore almost zero.

A further remedial measure for the volume loss in the event of a brake failure is provided by the implementation of the compensation piston in two parts, 40 and 41. In addition a hydraulic connection from the auxiliary piston 21 and the intermediate region of the two compensation pistons 40 and 41 is thereby created. This connection can be switched via the ES valve (add number). In the event of a failure of the brake circuit and brake servo, volume can be pumped by so-called feeding from the auxiliary piston 21 to the intermediate region of the two compensation pistons 40 and 41. For this, first of all the path simulator switch-on valve WA and the WD valve are closed and the ES valve is opened. Thus, if a brake circuit fails the compensation movement in the direction of the failed brake circuit is compensated, so that no volume is taken from the intact brake circuit. After a certain pressure is reached the ES valve is closed and the path simulator switch-on valve WA is opened. The fluid between the two compensation pistons 40 and 41 remains trapped however.

A further advantage in this connection is that the brake circuits are isolated from the pistons 16 and 17 via the compensation pistons 40 and 41. This has the advantage that if for example air is formed in the auxiliary piston when feeding in, no undesired air can reach the brake circuits. In addition it is impossible for example in the case of leakage in the ES valve for the brake pressure to act retroactively on the auxiliary piston. Also, it cannot happen that for example in the step-back level volume flows from the wheels to the auxiliary piston on opening the ES valve. This could happen if the ES valve is opened while the pressure in the brake circuits is already higher than in the auxiliary piston.

It should also be mentioned that the EA valve can be used in order to reduce the necessary compensation volume significantly (e.g. to 2 cm³. If for example in a p-jump braking the necessary pressure and/or volume in both brake circuits differs markedly, it is possible to open the E/A valve (add number) of the circuit with the smaller volume, as soon as the compensation piston 40, 41 reaches the end position. The opening time can be recognised by estimating the position of the compensation pistons 40, 41 or by a pressure or current monitoring. By reducing the compensation volume to for example 2 cm³, in the event of a double fault “brake circuit failure and brake servo failure” the effective residual volume in the intact circuit and thus the residual braking action is improved. Accordingly the valve 44 and the two-part implementation of the compensation piston 40 and 41 can optionally be dispensed with.

The brake system according to FIG. 6 corresponds as regards other features largely to that of FIG. 1. To this extent protection is sought for the features and claims according to FIG. 6 also in combination with those of FIG. 1.

As the description of FIG. 1 shows, all pistons and cylinder chambers are integrated in the main cylinder. These can be connected by short leads to the HCU and the reservoir. It is possible to combine or integrate the HCU with the main cylinder housing. The ECU can conveniently, as in the case of current ESP, be mounted on the HCU since the valve coils are connected mechanically and electrically to the ECU.

### LIST OF REFERENCE NUMERALS

1 Brake pedal
2 Pedal plunger
3 Pedal plate
4 Sliding bearing
5 Guide bolts
6 Rod
7 Pedal restoring spring
7a Pedal restoring spring (alternative)
8 Spindle
9 Stator with coil
10 Motor housing
11 Rotor
12 Rotor bearing
13 Motor rotational angle sensor
13a Motor rotational angle sensor (alternative)
14 Permanent magnet
15 Pressure plate
16 Main cylinder piston 1
17 Main cylinder piston 2
18 Pedal path sensor actuation Master
19 Pedal path sensor actuation Slave
20 Spring element
21 Auxiliary piston
22 Main cylinder housing
23 Pedal path sensors
24 Reservoir
25 Pressure transducer
26 Path simulator
27 Throttle—non-return valve
28 Closing spring BV1
29 Magnet anchor with coil BV1
30 Guide rods
31 Sliding bearing
32 Spindle restoring spring
33 Piston restoring spring
33a Piston restoring spring (alternative)
34 Level encoder
35 Spindle flange
36 Torque support spindle
37 Non-return valve
39 Compensation element
40 Piston with seal 1
41 Piston with seal 2
42 Piston restoring spring 1
43 Piston restoring spring 2
44 Shut-off valve for compensation element
45 Additional piston 1
46 Additional piston 2
47 Actuating arm
EA Inlet-outlet valve SG
BV1 Bypass valve SG
BV2 Bypass valve SG
WA path simulator-inlet valve SO
ESV Feed valve SG
SV Wheel cylinder-switching valve
S Play

1. An electronically controllable brake system, the system including:
an actuation device;
a main brake cylinder arrangement including at least two parallel-arranged piston-cylinder units and a reservoir, which are connected via hydraulic lines and valves to wheel brakes;
a servo device; and
an electrically drivable valve device disposed between brake circuits allocated to the piston-cylinder units and configured to permit the regulated transfer of hydraulic fluid between the brake circuits and the reservoir.

2. The brake system according to claim 1, wherein the servo device comprises an electric motor with recirculating ball screw and nut spindle transmission.

3. The brake system according to claim 1, further comprising an additional piston-cylinder unit, in addition to the at least two parallel-arranged piston-cylinder units, wherein the additional piston-cylinder unit is configured to actuate a path simulator, wherein the additional piston-cylinder unit is arranged parallel to and centrally between the at least two parallel-arranged piston cylinder units.

4. The brake system according to claim 3, further including a sensor device arranged to be actuated by the additional piston-cylinder unit.

5-6. (canceled)

7. The brake system according to claim 1, wherein the at least two parallel-arranged piston-cylinder units are arranged to be actuated via a pressure plate and are mounted floating on the pressure plate.

8-9. (canceled)

10. The brake system according to claim 1, wherein the servo device comprises a linearly movable member, which is arranged to act via a pressure plate on the main cylinder arrangement.

11. (canceled)

12. The brake system according to claim 1, wherein bypass switching takes place via the valve device in a low pressure range of up to approximately 10 bar and in a higher pressure range of greater than 50 bar.

13. (canceled)

14. An electronically controllable brake system, the system including:
an actuation device;
a main brake cylinder arrangement including at least two parallel-arranged piston-cylinder units and a reservoir, which are connected via hydraulic lines and valves to wheel brakes;
a servo mechanism; and
an additional piston-cylinder unit with at least one compensation piston arranged between brake circuits, wherein the compensation piston is arranged to separate two operating chambers that are each connected to a respective brake circuit, wherein from at least one brake circuit a hydraulic line leads to a compensation container, and wherein a valve is arranged in the hydraulic line that leads to the compensation container.

15. The brake system according to claim 14, wherein the at least one compensation piston is divided and is configured to feed pressure medium between pistons via an inlet valve in the event of a malfunction of the servo mechanism.

16. (canceled)

17. The brake system according to claim 14, wherein a single 2/2-way magnet valve, configured for multiplexing, is allocated to a respective one of the wheel brakes, wherein, between the brake circuits, a hydraulic line is arranged, into which a 2/2-way magnet valve, configured as a bypass valve, is switched, and wherein from each of the brake circuits, a respective hydraulic line branches to the reservoir, into which respectively a further 2/2-way magnet valve is switched.

18-19. (canceled)

20. The brake system according to claim 14, further including:
a common 2/2-way magnet valve allocated to the wheel brakes of a brake circuit;
a single 2/2-way magnet valve, configured for multiplexing and allocated to a wheel brake of a further brake circuit; and
two 2/2-way magnet valves coupled to the reservoir and allocated to another wheel brake of this circuit,
wherein between the brake circuits, a hydraulic line is arranged, into which two 2/2-way magnet valves are switched, and
wherein a hydraulic line branches to the reservoir between the valves, into which a further 2/2-way magnet valve is switched.

21. (canceled)

22. A path simulator of a brake system the simulator comprising three operating regions with differently strong force rise, wherein a first one of the operating regions is using a restoring spring provided on an actuating unit of the brake system.

23. The path simulator according to claim 22, wherein switching on of the path simulator takes place via a path simulator valve, and wherein the switching on is adaptive, based at least in part on anti-lock braking system (ABS) regulator use or pedal speed.

24. A method for diagnosing tightness and functional capability of a vehicle braking system including the brake system according to claim 1, the method including:
detecting a leakiness inside or outside the brake system according to claim 1 is detected by a diagnosis, with or without anti-lock braking system (ABS) function, by comparing pressure or motor current with a piston part of the brake system, wherein said detecting uses a characteristic that is recorded during start-up of the vehicle; and
adapting the characteristic during running time of the vehicle if a change is detected.

25. The method according to claim 24, further including automatically checking tightness of an electrically drivable valve device between the piston cylinder units of the brake system by corresponding switching during a braking operation.

26. The method according to claim 24, further including checking a valve closing spring of bypass valves of the brake system using corresponding switching.

27. The method according to claim 24, further including closing a corresponding valve of the brake system in diagnosis of a leakiness outside a sub-unit of the brake system and thereby causing a three-circuit brake system to become active.

28. The brake system according to claim 1, wherein a single 2/2-way magnet valve, configured for multiplexing, is allocated to a respective one of the wheel brakes, wherein, between the brake circuits, a hydraulic line is arranged, into which a 2/2-way magnet valve, configured as a bypass valve, is switched, and wherein from each of the brake circuits, a respective hydraulic line branches to the reservoir, into which respectively a further 2/2-way magnet valve is switched.

29. The brake system according to claim 1, further including:
a common 2/2-way magnet valve allocated to the wheel brakes of a brake circuit;
a single 2/2-way magnet valve, configured for multiplexing and allocated to a wheel brake of a further brake circuit; and
two 2/2-way magnet valves coupled to the reservoir and allocated to another wheel brake of this circuit,
wherein between the brake circuits, a hydraulic line is arranged, into which two 2/2-way magnet valves are switched, and
wherein a hydraulic line branches to the reservoir between the valves, into which a further 2/2-way magnet valve is switched.

30. A method for diagnosing tightness and functional capability of a vehicle braking system including the brake system according to claim 14, the method including:
detecting a leakiness inside or outside the brake system according to claim 14 is detected by a diagnosis, with or without anti-lock braking system (ABS) function, by comparing pressure or motor current with a piston part of the brake system, wherein said detecting uses a characteristic that is recorded during start-up of the vehicle; and
adapting the characteristic during running time of the vehicle if a change is detected.
